(19) United States
(12) Patent Application Publication
(10) Pub. No.: US 2009/0293690 A1
(43) Pub. Date: Dec. 3, 2009

(54) Method and Device for Cutting Up Bulky Metal Parts

(75) Inventors: Clemens HENSEL, Glattbach (DE); Oleg SCHMIDT, Aschaffenburg (DE)

Correspondence Address: DENNISON, SCHULTZ & MACDONALD, 1727 KING STREET, SUITE 105, ALEXANDRIA, VA, 22314, US

(73) Assignee: DUESMANN & HENSEL RECYCLING GMBH, Aschaffenburg (DE)

(21) Appl. No.: 12/476,478

(22) Filed: Jun. 2, 2009

(30) Foreign Application Priority Data
Jun. 3, 2008 (DE) 10 2008 002 876.2

(51) Int. Cl. B26D 3/16; B26D 1/30; B26D 7/01

(52) U.S. Cl. 83/54; 83/694; 83/391

(57) ABSTRACT

A method and a device for cutting up bulky metal parts using a shearing assembly that includes a fixed lower jaw including a first cutting edge and an associated horizontal first bearing surface for the metal part, and an upper jaw that can be swiveled relative to the lower jaw and including a second cutting edge, the cutting edges forming a V-shape at the beginning of the cutting-up process. To facilitate easy positioning of the metal parts between the upper and lower jaws, it is proposed to position the metal part on a support that is composed of a first bearing surface of the lower jaw and a second bearing surface stretching laterally next to the first and in vertical projection under the upper jaw, and that the upper jaw is moved towards the lower jaw while at the same time adjusting the second bearing surface together with the upper jaw.

### FIELD OF THE INVENTION

This invention relates to a method for cutting up bulky metal parts, in particular, automotive catalytic converters using a shearing assembly that includes a fixed lower jaw comprising a first cutting edge and an associated horizontal first bearing surface for the metal part, and an upper jaw that can be swiveled relative to the lower jaw and comprises a second cutting edge, the cutting edges forming a V-shape at the beginning of the cutting-up process.

The invention also relates to a device for cutting up an automotive catalytic converter that includes a lower jaw comprising a first cutting edge and an associated first bearing surface, an upper jaw that can be swiveled relative to the lower jaw and comprises a second cutting edge, and a hold-down device above the first section of the bearing surface, the first and second cutting edges forming a V-shape at the beginning of the cutting-up process.

### DESCRIPTION OF RELATED ART

Automotive catalytic converters are used for the post-treatment of exhaust gases in vehicles with internal combustion engines to reduce the emission of harmful substances in the exhaust gas. The typical design of automotive catalytic converters is a housing made of metal in which a carrier consisting of ceramic or metal sheets is placed that carries the so-called wash coat. Catalytically active precious metals such as platinum, rhodium, and/or palladium are embedded in this wash coat. The converters are mechanically prepared and chemically processed to reclaim the precious metals. The housings are cut open with hydraulic shears for mechanical preparation to facilitate the subsequent decomposition. If they contain metallic carriers, the cut-open catalytic converters are then cut up more, e.g. in a crossflow cutter, while precious metal particles as well as smaller particles from the supported catalyst are separated during or, preferably, after cutting-up. Separation during cutting-up is known from DE-C-41 22 717.

The catalytic converters can be cut using a hydraulic shearing machine like the one offered by JMC Recycling Systems Ltd., United Kingdom. The shears comprise a fixed lower jaw with a cutting edge, that is, a bottom part of the shears and a pivotable upper jaw with a cutting edge, that is, a top part of the shears. The lower jaw comprises a bearing surface on which the catalytic converter to be cut is positioned. Since the bearing surface only stretches along that side of the lower jaw that is outside the swiveling movement of the upper jaw, there is a risk that the catalytic converter may tip away when it protrudes too far from the cutting edge of the lower jaw. This is why the catalytic converter is typically held manually by the operator whose hand may be crushed if it is not pulled away in time; tilting forces act on the catalytic converter during cutting that result in pivoting the catalytic converter towards the upper jaw from where the risk of crushing a person's limb arises.

If small objects are to be cut using such a cutting device, they generally cannot be properly positioned without a tool. According to the state of the art, such small parts are held, for example, using pliers. Such handling is inconvenient and entails the risk that the pliers themselves get into the swiveling range of the upper jaw.

DE-C-856 818 discloses scrap shears in which the cutting edge of the lower shear blade is set at an angle to the horizontal plane.

To cut metal or concrete, U.S. Pat. No. 5,715,603 proposes a cutting device with lower and upper cutting arms and a shock-absorbing member that is to prevent the cutting arms from lateral displacement from each other.

DE-U-20 2004 012 247 proposes a cutting device for cutting wire bundles or wire cables that comprises horizontally pivotable cutting jaws, one of which comprising multiple recesses arranged at a spacing from each other.

Scrap shears designed particularly for cars are known from DE-A-31 36 832. The scrap shears are mounted on a machine frame with a pit into which the car to be cut is inserted. A forked pressure jaw device that includes a stroke part and a cutting part is provided for cutting and compressing.

Scrap shears, e.g. for containers, boilers or car bodies according to DE-C-845 438 comprise a blade carriage that can be moved in the horizontal plane in a machine frame and has a freely accessible charging hole on its top end. The charging hole can be made smaller by adjusting the blade carriage so that it fulfills the function of a pre-crushing space.

For dismantling an oil filter comprising a housing and a bottom, DE-U-91 16 858 proposes a device that has a lower blade with a thickness adequate for the thickness of the filter bottom. A pivotable upper blade is provided close to the lower blade.

### SUMMARY OF THE INVENTION

It is the object of this invention to further develop a method and device of the type mentioned at the outset in such a way that the metal parts such as catalytic converters can be positioned with ease between the upper and lower jaws. Another object is to reduce the risk of crushing one's hand when holding the metal part such as a catalytic converter by hand during the cutting process.

According to the invention, this object is generally achieved by a method of the type mentioned at the outset in that
the metal part is positioned on a support that is composed of a first bearing surface of the lower jaw and a second bearing surface stretching laterally next to the first and in vertical projection under the upper jaw, and
swiveling the upper jaw in the direction of the lower jaw while at the same time adjusting, preferably synchronously, the second bearing surface together with the upper jaw.

In deviation from the previously known method, a support is provided that stretches on both sides of the cutting edge of the lower jaw so that the metal part to be cut up can easily be positioned while the bearing surface that runs directly under the upper jaw does not obstruct the cutting process. The second bearing surface is lowered in coordination with the cutting process to free the cutting space.

The second bearing surface, also called bed extension, thus ensures that the metal part will not tip away and fall while it is being positioned. At the same time, cutting space is made available because the bed extension, that is, the bearing surface that stretches directly under the upper jaw, does not limit the cutting space. The spacing between the bearing surface that may for example be formed by the outer surface of an L-profile and the lower jaw, i.e. the surface that faces it on the cutting side, can be kept very small.

For improved positioning and preventing the metal part from uncontrolled displacement before it is cut, the device fixes and clamps the metal part at the beginning of the cutting process between the cutting edges of the upper and lower jaws.

In a further embodiment of the invention, a hold-down device that stretches from the upper jaw along the first support section is synchronously adjusted with the movement of the upper jaw. This ensures that the tilting forces that act on the metal part in the cutting process cannot tilt the part that is positioned along the stationary support section in such a way that the metal part moves towards the side facing the upper jaw resulting in forming a spacing that poses a risk of crushing a person's limb. Regardless of this, the traveling hold-down device prevents the ejection or chipping off of cut material.

The section of the hold-down device that is close to the support section has a spacing a to the cutting edge of the upper jaw of a >5 cm, particularly 5 cm<a<10 cm, so that voluminous or bulky metal parts such as catalytic converters can be cut without the hold-down device obstructing the cutting process, however the hold-down device prevents tilting that would pose the risk of crushing a person's limb.

If the hold-down device were preferably rigidly connected to the upper jaw or if it were an integral part thereof, the invention could be further developed by the option that the hold-down device stretching from the upper jaw be suspended on the upper jaw so that it can be adjusted in the direction of the swiveling movement. This adjustment or “giving way” can be achieved by resilient suspension, for example.

A device of the type mentioned at the outset is characterized in that a second bearing surface that can be lowered stretches along the side of the first cutting edge and expands the area of the first bearing surface, said second bearing surface preferably being in linkage with the upper jaw, and/or that the hold-down device is designed to synchronously follow the upper jaw and stretches at a distance a in swiveling direction from the second cutting edge on the support side, wherein a can be >4 cm or >5 cm, for example. The take-down device in particular is a protrusion projecting laterally away from the upper jaw or forming an integral part thereof. Alternatively, the hold-down device can be pivoted in the upper jaw so that it can move in the direction of the swiveling movement. The hold-down device can be textured on the side facing the bearing surface or designed like a tooth or claw to secure the material to be cut.

It is a known procedure to use shears in which a hold-down device is connected to an upper blade for cutting metal parts. However these metal parts are flat objects such as sheets. The hold-down device stretches at the level of the cutting edge of the upper jaw with the result that bulky parts cannot be cut (DE-C-33 09 369).

Gate shears for metal sheets according to DE-U-1 884 150 are equipped with an adjustable hold-down device that fixates the sheet metal before it is cut. A similar design can be found in DE-B-1 502 879.

According to the state of the art, two basic solutions for hold-down devices are generally known. Adjustable hold-down devices that remain stationary during cutting and hydraulic hold-down devices that are lowered before cutting are known. The stationary solution has the setbacks that it has to be adapted individually to each size of material to be cut and that the distance to the upper blade typically is quite wide. The latter characteristic results in a considerable risk of crushing a person's limb.

Automatic hydraulic hold-down devices pose a risk of crushing a person's limb per se because they have to hold down the material to be cut with the respective force and close where the operator will hold the part if the distance to the upper blade is wide enough. But if it is locked in the upper position, a classic crushing point is created because the material to be cut will “rear up” exactly towards this section.

All these setbacks are avoided by the hold-down device according to the invention since this device moves at an adequate distance from the cutting edge together with the upper jaw towards the material to be cut, thus adapting individually.

The second bearing surface of the device according to the invention, i.e. a support area that provides it such as the upper surface of the horizontal leg of an L-profile is preferably rigidly linked with the upper jaw to enable synchronous adjustment between upper jaw and support area, that is, widening of the bed.

### BRIEF DESCRIPTION OF THE DRAWINGS

Other details, advantages and characteristics of the invention can be derived not only from the claims but also from the subsequent description of an embodiment that can be seen in the figure, in which:

FIG. 1 shows a front view of a device according to the invention for cutting up metal parts such as catalytic converters,

FIG. 2 shows a lateral view of the upper and lower jaws of the device according to FIG. 1,

FIG. 3 shows a diagrammatic view of the upper and lower jaws of the device according to FIG. 1 with a metal part to be cut in the form of a catalytic converter positioned between them, and

FIG. 4 shows the schematic diagram of upper and lower jaws according to FIG. 3 during one working cycle.

### DESCRIPTION OF THE PREFERRED EMBODIMENTS

The figures in which the same elements generally have been assigned the same reference symbols show schematic views of a cutting device 10 for cutting up bulky metal parts 12, such as, in particular, automotive catalytic converters. The objective with catalytic converters is to cut through their housing for further mechanical processing. However, the invention is not limited to catalytic converters.

The device 10 includes a stationary lower jaw 14 and an upper jaw 16 that can be swiveled relative to the former. Lower and upper jaws 14, 16 comprise cutting edges 18, 20 to cut through the metal parts 12. When the upper jaw 16 is swiveled, its cutting edge 20 is pivoted at a small spacing along the cutting edge 18 of the lower jaw 14 as is known from shearing-type cutting devices. The lower jaw comprises a first bearing surface 22 for the metal part to be cut up on its side that faces the upper jaw 16.

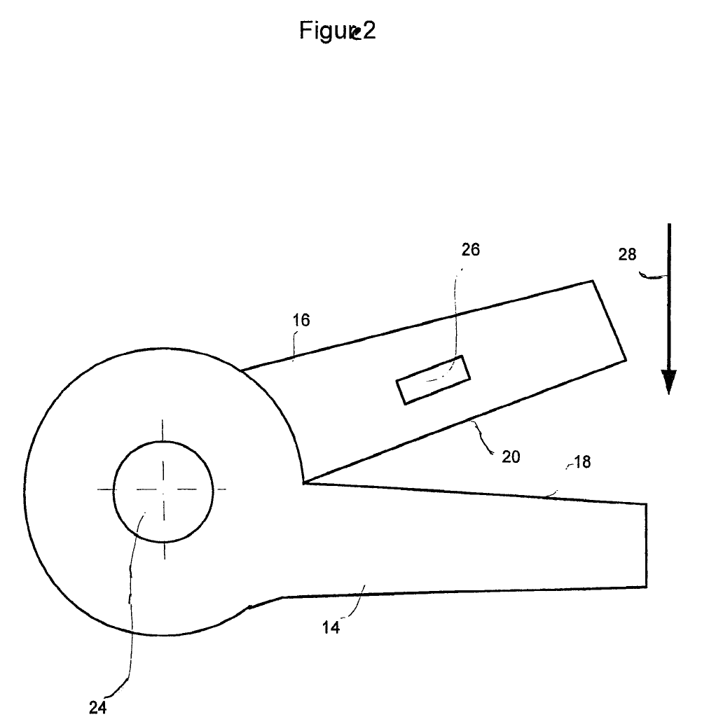

As can be seen from FIG. 2, the upper jaw can be swiveled about an axis 24 relative to the lower jaw 14 so that the cutting edges 18, 20 form the legs of a “V,” the tip of which is on the axis.

A hold-down device 26 stretches from the upper jaw 16 and preferably forms a rigid unit with the upper jaw 16. Another option is to suspend the hold-down device 26 in such a way in the upper jaw 16 that it can be adjusted against the direction of the cutting motion (arrow 28) of the upper jaw 16 to back away to a certain extent from a metal part to be cut. Such a suspension can be achieved using springs.

Regardless of this, the lower side 27 of the hold-down device 26 that faces the bearing surface stretches at a distance a from the cutting edge 20, said distance being at least 5 cm. This ensures that the cutting of bulky metal parts such as automotive catalytic converters 12 is not obstructed while at the same time the risk of crushing a person's body parts is eliminated.

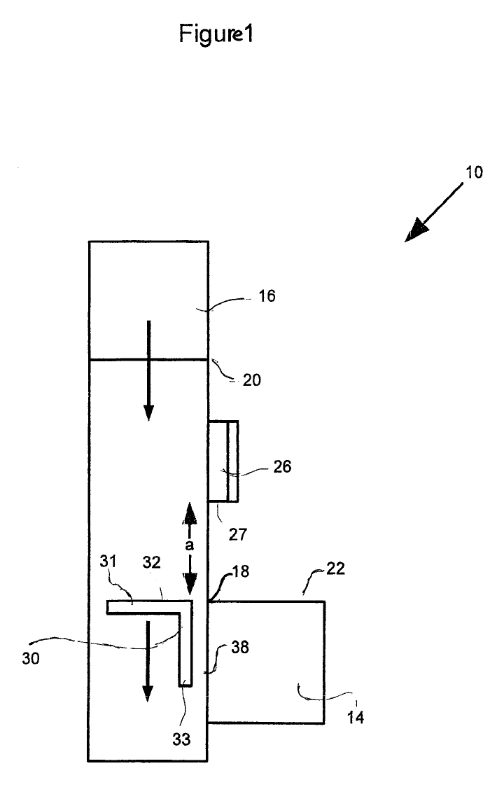

FIG. 1 further illustrates that a support area 30 for the metal part to be cut up runs next to the lower jaw 14 that provides a bearing surface 22 on its top side, and that the top side 32 of said support area in the initial state forms a flush or almost flush transition to the bearing surface 22 of the lower jaw 14. The support area can be an L-profile the horizontal leg 31 of which forms the bearing surface 32. The leg 33 that faces away from the horizontal leg 31 at a 90° angle is vertically oriented and runs along the outer surface 38 of the bearing surface of the lower jaw 14.

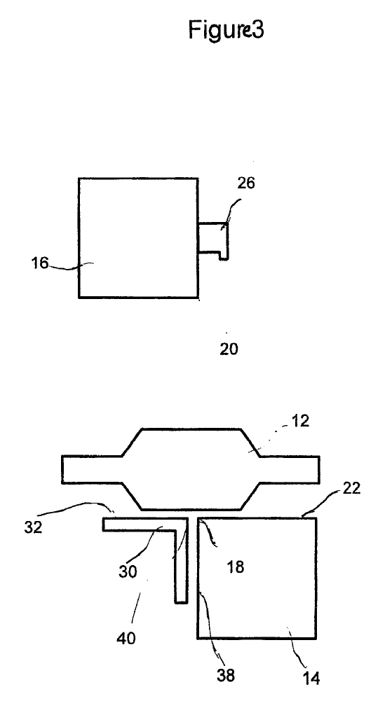

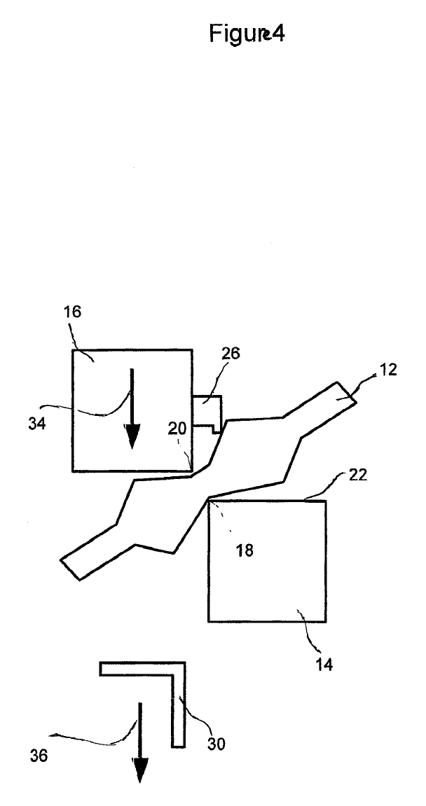

As FIG. 3 illustrates, the support area 30, i.e. its upper free surface 32 forms the overall support for the catalytic converter 12 together with the bearing surface 22 of the lower jaw 14 so that the converter can be positioned securely regardless of how far the catalytic converter 12 protrudes beyond the cutting edge 18. The support area 30 however is coupled with the upper jaw 16 in such a way that the support area 30 is synchronously adjusted when the upper jaw 16 is swiveled, which is illustrated by the arrows 34, 36 in FIG. 4. The support area 30 therefore is no obstruction during the cutting cycle but it can be positioned very closely along the outer bearing surface 38 in the base position (FIG. 3) so that there has to be kept only a small gap between the support area 30 and the lower jaw 14.

It can also be seen from FIG. 4 that the hold-down device 26 that tracks along during cutting prevents ejection or chipping off of material from the catalytic converter after cutting but ensures that the section of the catalytic converter 12 that stretches above the lower jaw 16 is not moved towards the upper jaw 14 due to the tilting forces that occur in the cutting process that the risk of crushing a person's limb arises.

The hold-down device 26 can be textured on its side that faces the lower jaw to provide additional fixation for the catalytic converter 12 so that there won't be any uncontrolled displacement during cutting.

What is claimed is:

1. A method for cutting up bulky metal parts (12), in particular, automotive catalytic converters using a shearing assembly (10) that includes a fixed lower jaw (14) comprising a first cutting edge (18) and an associated horizontal first bearing surface (22) for the metal part, and an upper jaw (16) that can be swiveled relative to the lower jaw (14) and comprises a second cutting edge (20), the cutting edges forming a V-shape at the beginning of the cutting-up process, characterized in that:
the metal part (12) is positioned on a support that is composed of a first bearing surface (22) of the lower jaw (14) and a second bearing surface (32) stretching laterally next to the first and in vertical projection under the upper jaw (16), and
swiveling the upper jaw in the direction of the lower jaw while at the same time adjusting the second bearing surface together with the upper jaw.

2. The method according to claim 1, characterized in that the second bearing surface (32) is synchronously adjusted with the swiveling of the upper jaw (16).

3. The method according to claim 1, characterized in that the metal part (12) is fixed between the cutting edges (18, 20) of the lower and upper jaws (14, 16) at the beginning of the cut-up process.

4. The method according to claim 1, characterized in that a hold-down device (26) stretching from the upper jaw along the first bearing surface (22) and at a spacing in swiveling direction from the second cutting edge (20), is adjusted synchronously with the movement of the upper jaw (16).

5. The method according to claim 4, characterized in that the hold-down device (26) forms an integral part of the upper jaw (16) or is firmly or immovably connected to it.

6. The method according to claim 4, characterized in that the hold-down device (26) that stretches from the upper jaw (16) is suspended on the upper jaw so that it can be adjusted in the direction of the swiveling movement.

7. The method according to claim 1, characterized in that the second bearing surface (32) is rigidly connected to the upper jaw (16).

8. A device (10) for cutting up an automotive catalytic converter (12) that includes a lower jaw (14) comprising a first cutting edge (18) and an associated first bearing surface (22), an upper jaw (16) that can be swiveled relative to the lower jaw and comprises a second cutting edge (20), and a hold-down device (26) above the first bearing surface, the first and second cutting edges forming a V-shape at the beginning of the cutting-up process, characterized in that a second bearing surface (32) that can be lowered stretches along the side of the first cutting edge (18) and widens the area of the first bearing surface (22), and/or the hold-down device (26) is designed to synchronously follow the upper jaw (16) and stretches at a distance a in swiveling direction of the upper jaw (16) from the second cutting edge (20) on the side facing the bearing surface.

9. The device according to claim 8, characterized in that the second lowerable bearing surface (32) is functionally connected with the upper jaw (16).

10. The device according to claim 8, characterized in that the hold-down device (26) is a protrusion projecting laterally from the upper jaw (16).

11. The device according to claim 8, characterized in that the hold-down device (26) forms an integral part of the upper jaw (16).

12. The device according to claim 8, characterized in that the hold-down device (26) is suspended in the upper jaw so that it can be adjusted in the direction of the swiveling movement of the upper jaw (16).

13. The device according to claim 8, characterized in that the hold-down device (26) is textured on the side facing the bearing surface.

14. The method according to at least claim 13, characterized in that the hold-down device (26) is structured like a tooth or claw on the side facing the bearing surface.

15. The device according to claim 8, characterized in that the second bearing surface (32) is rigidly connected to the upper jaw (16).

16. The device according to claim 8, characterized in that the second bearing surface (32) is the outer side of a horizontal leg (1) of a support (30), preferably in the form of an L-profile.

17. The device according to claim 8, characterized in that the spacing a between the hold-down device (26) and the second cutting edge (20) is a >4 cm, preferably a >5 cm, particularly preferred 5 cm<a<10 cm.
